(19) United States
(12) Patent Application Publication
(10) Pub. No.: US 2014/0284422 A1
(43) Pub. Date: Sep. 25, 2014

(54) Hovering Surveillance Air Vehicle

(71) Applicant: Itzhak Sapir, Irvine, CA (US)

(72) Inventor: Itzhak Sapir, Irvine, CA (US)

(21) Appl. No.: 13/848,443

(22) Filed: Mar. 21, 2013

(51) Int. Cl. B64B 1/00

(52) U.S. Cl. CPC B64B 1/00
USPC 244/96

(57) ABSTRACT

A hovering surveillance device. An electronic imaging device is disposed on a housing having a primary lift element, at least one compressed lighter-than-air gas element, a pitch adjustment element, and, a steering element. The compressed lighter-than-air gas is channeled to the primary lift element and the pitch adjustment element to selectively vary the altitude and angle for the housing such that scene of interest may be imaged. The lighter-than-air gas may be selected from the group of helium, hydrogen, heated air, neon, ammonia, and methane.

### CROSS-REFERENCE TO RELATED APPLICATIONS

This application claims the benefit of U. S. Provisional Patent Application No. 61/613,544, filed on Mar. 21, 2012 entitled “Hovering Surveillance Air Vehicle” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of aerial surveillance devices. More specifically, the invention relates to a lighter-than-air, floating or hovering surveillance platform for extended remote monitoring of an area using an imaging device.

2. Description of the Related Art

Surveillance in urban areas and inside buildings is not easily achievable by using small micro-unmanned aerial vehicles (“UAV”s) due in part to the lack of platform stability and potential collision of the vehicles into the structures.

Further, when there is a need for prolonged monitoring of an area, small and micro-UAVs also lack electrical power to remain aloft for long periods of time.

The device of the invention overcomes the deficiencies in prior art aerial surveillance devices and provides a stable, easy to control platform for prolonged monitoring of urban areas of interest and inside buildings.

### BRIEF SUMMARY OF THE INVENTION

In a first aspect of the invention, a surveillance device is disclosed comprising a housing, an electronic imaging device, a primary lift element, at least one compressed lighter-than-air gas element, a pitch adjustment element, and, a steering element.

The lighter-than-air gas may be selected from the group of helium, hydrogen, heated air, neon, ammonia, and methane.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts the device of the invention in its deployed mode.

FIG. 2 depicts the device of the invention in cross-section showing selected major components.

FIG. 3 depicts an exemplar imaging device for use in the invention in the form of a payload for use in both day and night operation.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Turning now to the figures wherein like references define like elements among the several views, Applicant discloses a hovering surveillance platform for extended remote imaging of an area.

The hovering surveillance aerial vehicle is a lighter-than-air system. In a first aspect of the invention, a surveillance device or vehicle is disclosed comprising a housing, an electronic imaging device, a primary lift element, at least one compressed lighter-than-air gas element, a pitch adjustment element, and, a steering element.

The lighter-than-air gas may be selected from the group of helium, hydrogen, heated air, neon, ammonia, and methane.

The configuration of hovering surveillance aerial vehicle of the invention may be provided in the form of a mortar shell projectile that is launchable from a mortar tube but the invention is not limited to such a configuration. Other configurations contemplated by the invention may include projectiles launched from dedicated launchers including mechanical launchers.

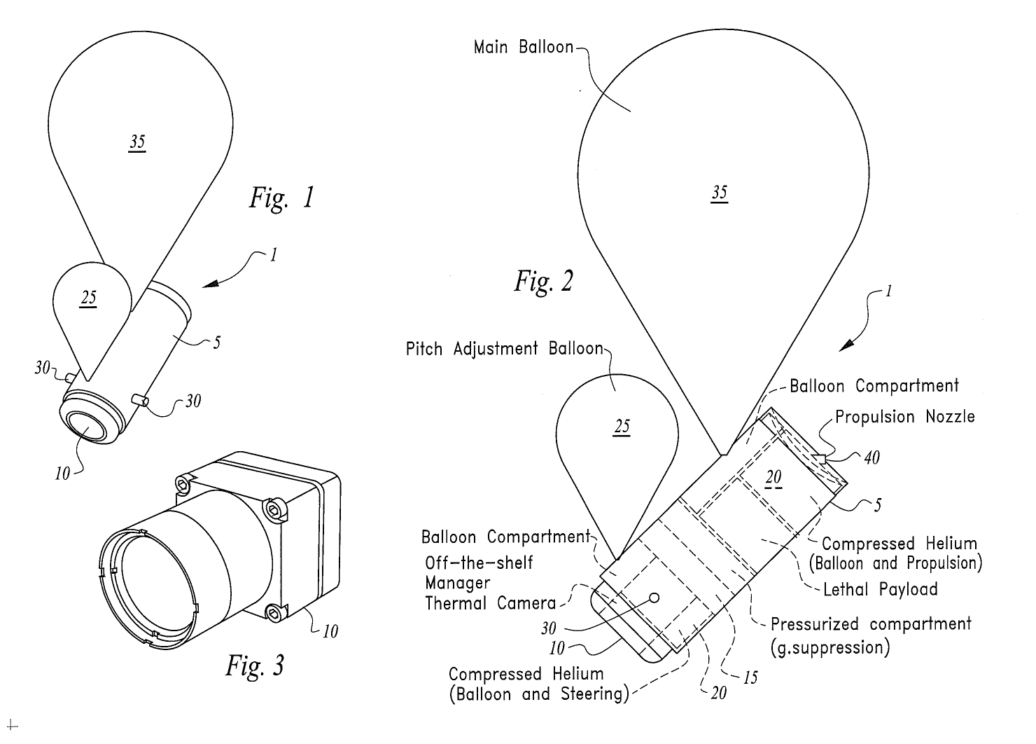

As is depicted in FIGS. 1 and 2, the hovering surveillance aerial vehicle or device 1 of the invention comprises a housing 5 that is divided into “compartments” having different roles in device's 1 operation.

Housing 5 may comprise a miniature thermal camera or other imaging or sensor element 10 with suitable electronics and power assembly 15. Imaging or sensor element 10 of the invention may be configured to wirelessly transmit electronic images to a predetermined ground station.

A compressed lighter-than-air gas volume or element 20 for storing a compressed gas may be provided around or adjacent imaging or sensor element 10 and is a part of housing 5. Compressed lighter-than-air element 20 may be configured to hold a compressed lighter-than-air gas in a bottom-sealed, U-shaped volume.

Housing 5 may further comprise a pitch adjustment element 25 which may be in the form folded balloon or similar structure disposed in an upper, non-sealed volume.

Two steering nozzle elements 30 may be provided on housing 5 and may be located on two opposing sides of housing 5 and configured such that when compressed gas in compressed lighter-than-air gas element 20 is released through steering nozzle elements 30, the channeled gas flow through the selected nozzle element 30 urges housing 5 in a direction opposite the flow of the gas while housing 5 is suspended in the atmosphere. In other words, nozzles 30 are configured to selectively urge housing 5 in a user defined left or right direction using a compressed gas.

Steering nozzle elements 30 function in cooperation with compressed lighter-than-air gas elements 20 using suitable gas valving and gas valve control means.

Electronics and battery assembly 15 are disposed adjacent a second sealed, compressed lighter-than-air gas element 20 which may be provided and, if desired, used as cushion for G-load suppression for the electronics and camera assemblies during a mortar launch.

Further, to the rear of housing 5, a compartment for a lethal payload may be provided along with a separate sealed compressed lighter-than-air gas element 20 for compressed helium or selected lighter-than-air gas for use with a primary lift element 35.

Primarily lift element 35 may comprise a main balloon inflation element or similar structure.

Compressed lighter-than-air gas element 20 is used to power the horizontal or drive propulsion of vehicle 1 using propulsion nozzle 40 in cooperation with a compressed lighter-than-air gas element 20 and suitable valving and valve control means.

The compartment holding primary lift element 35 may be located above or adjacent two rear compartments in housing 5 and a propulsion nozzle 40 provided at the rearward end of housing 5. Propulsion nozzle 40 is preferably configured to be oriented or disposed at an angle that is approximately horizontal when the hovering aerial surveillance vehicle is deployed.

Hovering aerial surveillance vehicle 1 is preferably launched with a protective cover mounted on the lens of imaging or sensor element 10. Once housing 5 reaches the required or predetermined distance from the launcher, timed using an acceleration-triggered timer, the protective cover is ejected and primary lift element 35 and pitch adjustment element 25 inflate, causing housing 5 to decelerate and eventually “stop” and hover in mid-air.

At this point in the deployment sequence, the hovering height and pitch angle may be adjusted by inflating or deflating each of primary lift element 35 and pitch adjustment element 25 as needed or determined by the user.

The direction of the line-of-sight of imaging or sensor element 10 may be controlled by the one or more steering nozzle elements 30 disposed at the front of housing 5. System propulsion may be accomplished by firing propulsion nozzle 40 by channeling a compressed gas there through.

All three nozzles (right and left nozzles 30 and propulsion nozzle 40) may be configured to use residual helium or compressed gas pressure from the compressed lighter-than-air gas elements 20.

In this manner, hovering aerial surveillance vehicle 1 may be provided to loiter above a predetermined area of interest, transmitting imagery and GPS information using suitable wireless transmitting circuitry while consuming no power for hovering.

The direction and position of vehicle 1 may be continuously monitored and corrected using short bursts of compressed gas from the three nozzles directed by a user from a ground station that is in electronic communication using suitable control electronics in device 1.

For maneuvering along a 3-D path, including entering buildings and performing final approach to a target, a combination of primary lift element 35 and pitch adjustment element 25 deflation and propulsion and steering bursts may be used with an optional “drop” of device 1 above a target at the end of an operation. This drop may be performed by releasing primary lift element 35 and pitch adjustment element 25 from housing 5 when above the target.

As an alternative to the mode of operation described above, a second mode of operation is provided where hovering aerial surveillance vehicle 1 lands on the ground or at a predefined landing location close to the area of interest at the end of its ballistic flight. When surveillance of the area is needed, the primary lift element 35 and pitch adjustment element 25 inflate and the vehicle 1 and its payload resume hovering.

The hovering aerial surveillance vehicle 1 electronics may include a wireless data transceiver, a GPS receiver, nozzle control electronics, accelerometers, compass means, an inclination sensor or an altitude sensor or any combination of same. An optional lethal payload may occupy a designated compartment in housing 5.

Protecting the imaging or sensor element 10 and electronics and power assembly 15 from the launch G-loads is achieved by optimizing the volume and pressure of the pressurized cushion against in which the moving components are compressed.

The use of gas flow control vents minimizes G-loads during launch. When launch is complete, the pressurized cushion pushes the flexibly-mounted imager 10 and electronics back toward the final operating position.

The hovering altitude, compass heading and pitch angle may be used to calculate the correct GPS location of a target on the ground.

One or more communication antennas may be attached to the outer skin of housing 5. This is best achieved if the material of housing 5 is non-metallic such as a plastic material.

A ground tether or leash (not shown) may be provided to limit travel or retrieve vehicle 1 by a user after launch.

If a metal housing material is used, a spring-loaded antenna holder may be employed to urge the antenna away from housing 5 when primary lift element 35 and pitch adjustment element 25 deploy.

The amount of residual compressed gas for maneuvering and propulsion depends on the volume of the compressed lighter-than-air gas elements 20. A practical problem in the device operation concerns whether the amount of lighter-than-air gas needed to inflate primary lift element 35 and pitch adjustment element 25 cannot be stored in compressed lighter-than-air gas elements 20 at a reasonable pressure (i.e., the volume ratio renders the stored pressure too high).

A first embodiment is configured whereby vehicle 1 comprises two separable parts, the housing 5 having the compressed lighter-than-air gas elements 20 and a hovering system of a similar design as described above. The hovering system is configured to store compressed gas for propulsion and maneuvering while the compressed lighter-than-air gas for inflating the balloons is stored in housing 5.

At the time of launch, a secondary helium storage bag having aerodynamic shape is configured to begin inflating using the compressed lighter-than-air gas stored in housing 5.

A folded bag is stored in the rear portion of the hovering system's housing 5 and has a volume and wall stiffness to permit a buildup of an initial pressure that is used to complete inflating the primary lift element 35 close to the area of interest. When the compressed lighter-than-air gas is transferred to the secondary bag and to the semi-inflated balloons, the front portion of device 1, including the housing and pressure vessel, detach from the hovering system and continue their ballistic trajectory while the balloons' inflation is completed using helium from the secondary bag. The secondary bag is detached and dropped when its role is complete.

A second embodiment adopts an approach based on a Cornish Hydrogen Generator. This embodiment takes advantage of a very simple chemical-reaction hydrogen generator that mixes aluminum powder, water and sodium hydroxide. The ingredients are stored in housing 5 and are instantaneously mixed at the time of launch. The hydrogen generated during the ballistic flight begins inflating the secondary storage bag discussed above and when it reaches its target pressure closer to the area of interest, primary lift element 35 begins to inflate.

A third embodiment provides an on-board hydrogen generator as described in the previous section but without the secondary storage bag. An advantage in having the secondary storage bag described in the previous approach is the primary lift element 35 and pitch adjustment element 25 cannot be inflated during ballistic flight or will slow the projectile and will not allow it to reach the desired range.

In this third approach, a small parachute similar to those used in illumination mortar shells may be provided and is packed in the front protective cover of housing 5. The parachute is configured to open at the high point in the housing trajectory and only then does the on-board hydrogen generator begin inflating the main balloons.

When controlled hovering is achieved, the protective cover and the parachute are both ejected. The folded parachute in this approach is lighter and consumes less volume than the embodiment comprising a folded secondary storage bag.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A surveillance device comprising:
a housing,
an electronic imaging device,
a primary lift element,
at least one compressed lighter-than-air gas element,
a pitch adjustment element, and,
a steering element.

2. The device of claim 1 wherein the lighter-than-air gas is selected from the group of helium, hydrogen, heated air, neon, ammonia, and methane.

3. The device of claim 1 wherein the compressed lighter-than-air element comprises hydrogen supplied by a Cornish Hydrogen Generator disposed in the housing.
